(19) United States
(12) Patent Application Publication
(10) Pub. No.: US 2019/0330766 A1
(43) Pub. Date: Oct. 31, 2019

(54) Apparatus for removing moisture from a section of polymer filament

(71) Applicants: Dennis Joseph Steibel, JR., Lake Zurich, IL (US); Richard David Fraser, Barlett, IL (US)

(72) Inventors: Dennis Joseph Steibel, JR., Lake Zurich, IL (US); Richard David Fraser, Barlett, IL (US)

(21) Appl. No.: 16/395,180

(22) Filed: Apr. 25, 2019

Related U.S. Application Data
(60) Provisional application No. 62/664,127, filed on Apr. 28, 2018.

(51) Int. Cl. D01F 1/00; B29C 64/295; D01D 5/096; D01D 10/02

(52) U.S. Cl. CPC D01F 1/00; D01D 10/02; D01D 5/096; B29C 64/295

(57) ABSTRACT

The present invention is an apparatus used for the removal of moisture from of a section of polymer filament just prior to its consumption by an external process. The apparatus removes moisture by heating the polymer filament in a controlled manner to a temperature which releases the moisture from the polymer filament, but below the temperature that significantly distorts the polymer filament so that the mechanical structure of the polymer filament (diameter and linearity) is substantially maintained. As the polymer filament is externally consumed, it moves through the apparatus. The apparatus removes moisture from polymer filament more rapidly than other methods.

### CROSS-REFERENCE TO RELATED APPLICATIONS

Provisional application No. 62/664,127 filed on Apr. 28, 2018

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

Polymer filament including plastic filament, is routinely used in the additive manufacturing 3D printing process and other molding processes. 3D printer polymer filament is typically provided in a reel of varying size but typically holding 0.5 to 2 kilograms of polymer filament. While the invention is applicable to a wide range of polymer filament diameters, polymer filament is typically manufactured with a diameter of 1.75 mm or 3.0 mm.

Manufacturers ship the polymer filament reels in sealed packaging, however, once opened, the polymer filament can absorb moisture when exposed to the atmosphere. This absorbed moisture creates a quality problem when that plastic is used for 3D printing. The moisture in the plastic filament can turn into gas when rapidly heated at the printing nozzle in a 3D printer printhead and the escaping gas can create voids and which lead to poor quality in the 3D print.

When these quality problems occur users currently heat the entire reel of polymer filament in an oven or food dehydrator at a temperature that will release the moisture from the polymer filament. This temperature is maintained for several hours until enough moisture is released allowing 3D printing without voids. Only after the entire reel has been processed can the polymer filament be used. This process is inconvenient and time consuming.

### BRIEF SUMMARY OF THE INVENTION

The present invention is an apparatus used for the removal of moisture from a section of polymer filament as it is externally consumed.

Polymer filament moves through the apparatus just before the point of consumption. The apparatus removes moisture from the section of the polymer filament by heating the polymer filament in a controlled manner to a temperature which releases the moisture from the polymer filament, but below the temperature that significantly distorts the polymer filament so that the mechanical structure of the polymer filament (diameter and linearity) is substantially maintained.

Due to the differential in moisture content between the polymer filament and the surrounding air, the moisture is carried away by diffusion into the air surrounding the polymer filament. The air is exchanged in the apparatus to keep the differential in moisture content as great as possible.

Because the rate of reabsorption of water by the polymer filament is significantly less once the polymer filament leaves the apparatus, the polymer filament can be consumed shortly after exiting the apparatus without reabsorption of moisture.

The apparatus allows the user to remove moisture from polymer filament much more rapidly than other methods.

### BRIEF DESCRIPTION OF THE SEVERAL VIEWS OF THE DRAWING

FIG. 1. Depicts the preferred embodiment of the apparatus.

FIG. 2. Is a close up cross sectional view of the polymer filament entry portion of the apparatus.

FIG. 3a., 3b. Is a close up view of the preferred heater embodiments of the apparatus.

FIG. 4. Is a close up cross sectional view of the polymer filament exit portion of the apparatus.

FIG. 5. Depicts the block diagram of the temperature controller, inputs and outputs.

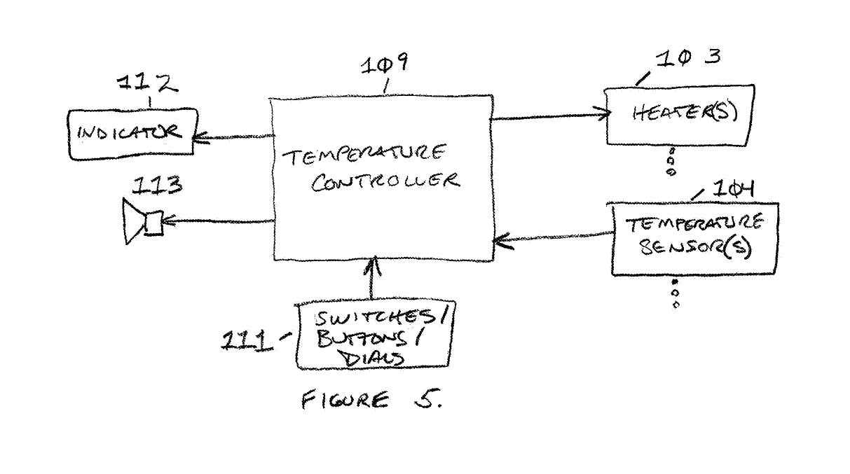

FIG. 6. Depicts a close up view of the air exchanger with desiccant.

FIG. 7. Depicts a close up view of the air exchanger with dehumidifier.

### DRAWINGS—REFERENCE NUMERALS

101—polymer filament

102—chamber

103—heater(s)

104—temperature sensor(s)

105—air exchanger

106—air coupling

107—entry

109—temperature controller

110—dehumidifier

111—switches/buttons/dials

112—visual indicator

113—speaker

115—desiccant

### DETAILED DESCRIPTION AND PREFERRED EMBODIMENT

### Preferred Embodiment Description of Figures

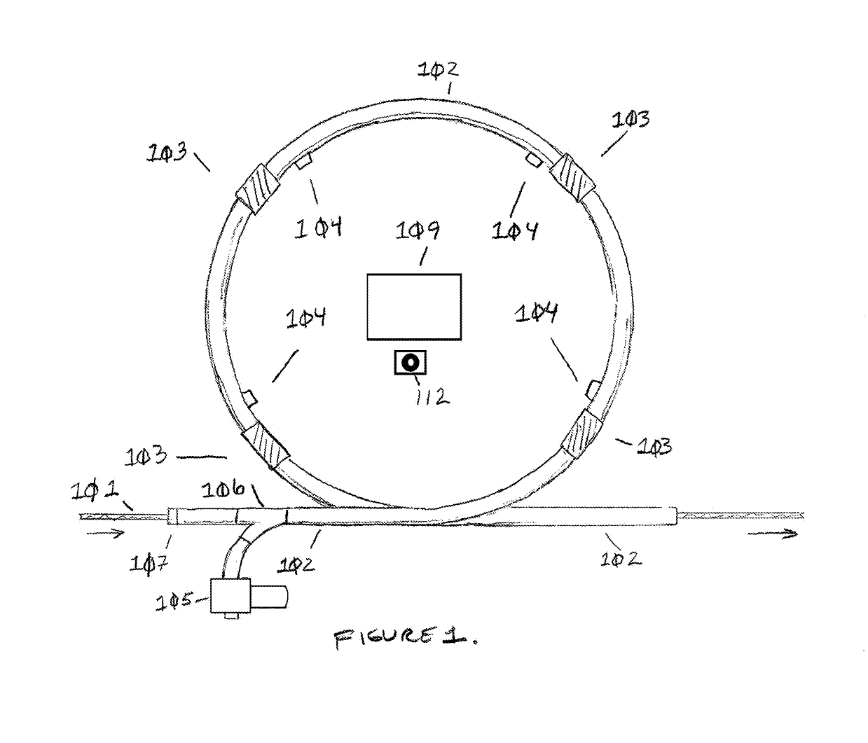

The preferred embodiment of the present invention is illustrated in FIG. 1. Chamber 102 is a metal tube made from an alloy of Copper and Nickel with an overall length of approximately 2 meters bent into a circular coil approximately 250 mm in diameter.

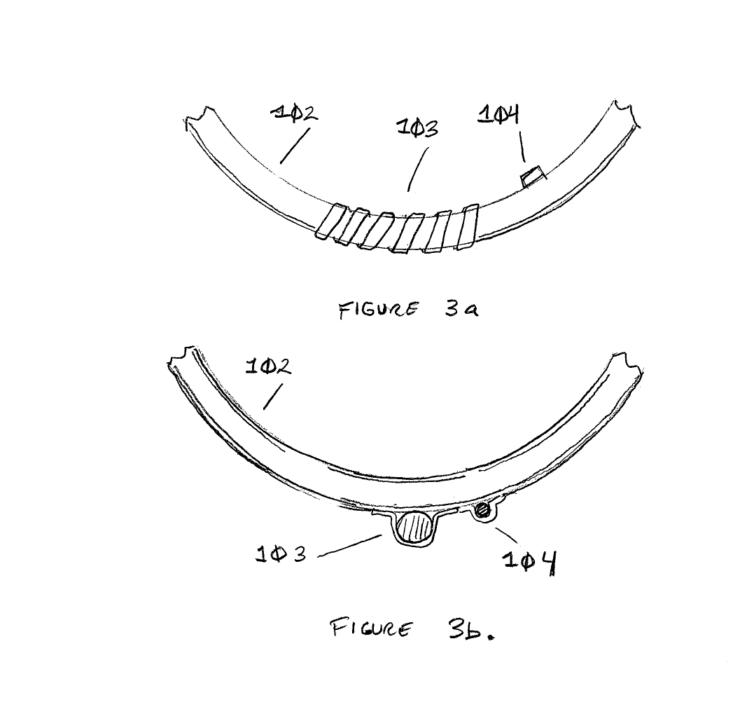

Heaters 103 are spaced evenly around and are attached directly to the chamber 102 allowing transfer of thermal energy to the chamber 102. The heaters 103 are made using resistor ceramic heating elements. FIG. 3b shows the heaters 103 and temperature sensors 104 attached to the chamber 102 using copper tabs soldered to the chamber 102 and thermally conductive adhesive binding them in the tabs. In an alternative embodiment, heaters 103 are resistive heating tape that is wrapped around the chamber 102 with temperature sensors 104 attached with thermally conductive adhesive as shown in FIG. 3a.

Referring again to FIG. 1, temperature sensors 104 are thermistors placed near the heaters 103.

The temperature sensors 104 and the heaters 103 are connected to a temperature controller 109 using suitable gauge wires. The temperature controller 109 is an electronic circuit that implements a simple temperature thermostat algorithm.

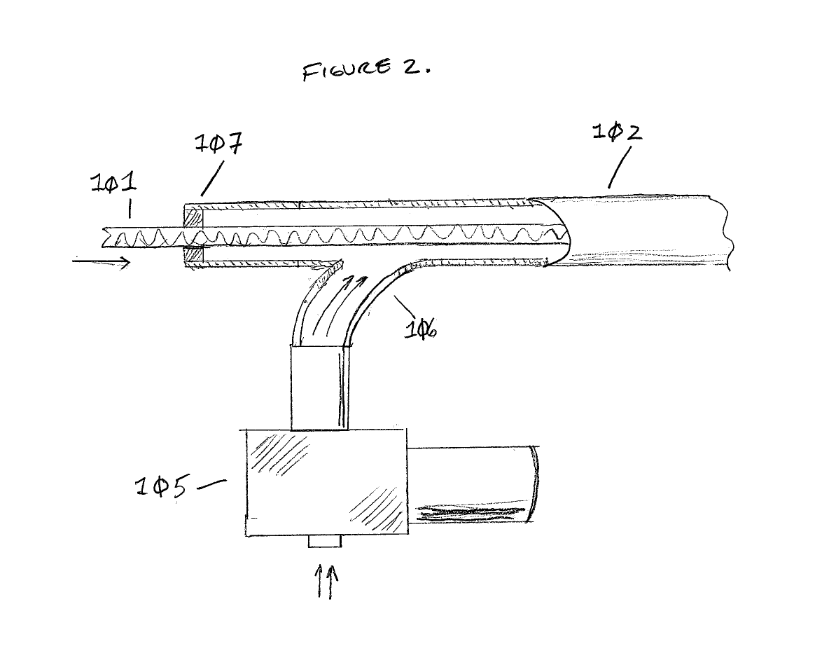

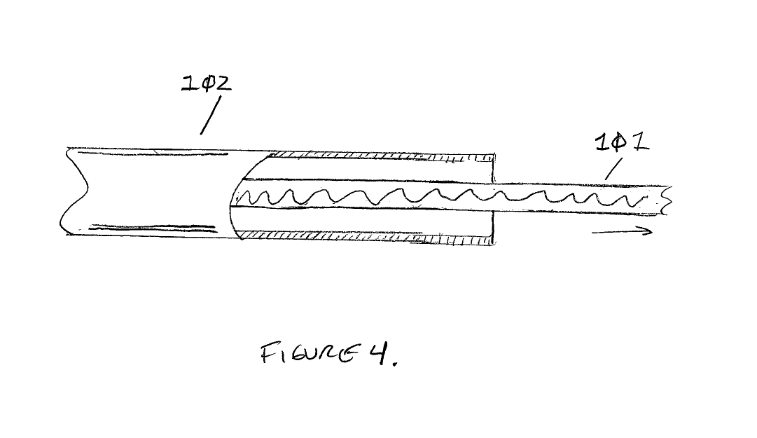

The front end of the chamber 102 has an entry 107 shown in FIG. 2. The entry 107 has an orifice that is slightly larger than the diameter of a polymer filament 101. The other end of the chamber 102 is open and has no restriction as shown in FIG. 4.

An air exchanger 105 shown in FIGS. 1,2,6 and 7, is connected to the chamber 102 through an air coupling 106. The air exchanger 105 is an air pump. Air coupling 106 is connected to the chamber 102 using solder. Silicone tube is used to connect the air coupling 106 to the air exchanger 105 to resist heat transfer and possible damage.

### Preferred Embodiment Operational Description

To use the apparatus, the polymer filament 101 enters the apparatus and is guided into the chamber 102 through an opening at the entry 107 of the chamber 102 as shown in FIG. 1. The polymer filament 101 is fed into the chamber 102 until it emerges through the end of the chamber 102.

With power applied to the temperature controller 109, the temperature of the polymer filament 101 is sensed using temperature sensors 104. The temperature controller 109 compares the temperature of the polymer filament 101 to the set desired temperature and the heaters 103 are energized to heat the polymer filament 101.

The chamber 102 is closed except for the entry 107, the air coupling 106 and opposite end of the chamber 102. The entry 107 diameter is very close to the diameter of the polymer filament 101 so that air flow is restricted. Air flows from the air exchanger 105 and into the chamber 102 through the coupling 106 and flows to exit the opposite end of the chamber.

Polymer filament 101 may be heated by conduction, convection and by radiation. In the preferred embodiment, all three modes of heat transfer to the polymer filament 101 are employed simultaneously. The chamber 102 is heated by the heaters 103 which in turn heat the polymer filament 101 by direct contact to the chamber 102. In addition, the polymer filament 101 is heated by radiation of heat from the chamber 102 to the polymer filament 101. Lastly, as the air travels from the air exchanger 105 to the coupling 106 and throughout its path to the chamber 102 end, it is heated by the chamber 102. The heated air moves across the polymer filament 101 and heats it. For different sized polymer filament 101 diameters, entry 107 is sized accordingly.

As the polymer filament 101 moves through the chamber 102, the polymer filament 101 will be heated and begin to liberate moisture by diffusion into the surrounding air. To remove the greatest amount of moisture from the polymer filament 101, the rate of diffusion must be kept as high as possible. This is done by keeping the differential between the level of moisture in the polymer filament 101 and the moisture in the air surrounding the polymer filament 101 as high as possible. To accomplish this, an air exchanger 105 exchanges the air in the chamber 102.

The set desired temperature is the temperature in a range that liberates moisture from a polymer. Different polymers begin to liberate moisture at different temperatures depending on the chemical makeup of the polymer and the surrounding air pressure. At typical atmospheric pressures and for typically used plastic polymers, such as Nylon, Acrylonitrile Butadiene Styrene (ABS), Polylactic acid or polylactide (PLA) and Polyethylene Terephthalate (PET), moisture liberates well at a temperature above 100 degrees Celsius and increases above this temperature. For typical plastic polymers, filament will not be significantly mechanically distorted (diameter and linearity) below 200 degrees Celsius. In the preferred embodiment, the temperature controller 109 regulates the temperature of the polymer filament 101 to a set desired temperature in a range between 140 and 190 degrees Celsius.

The set desired temperature may be a fixed value set in the temperature controller 109 that has been selected to work with a range of different polymer filaments.

In the preferred embodiment more than one temperature sensor 104 is used to measure the temperature of the polymer filament 101. The temperature of the polymer filament 101 is measured indirectly by measuring the temperature of the chamber 102 at the point of contact of the heaters 103. Each temperature sensor 104 is used by the temperature controller 109 to control a separate heater 103 thereby simultaneously controlling the temperature of different portions of the section of polymer filament 101. A separate electronic circuit is used to implement the temperature thermostat algorithm for each temperature sensor 104 and heater 103 pair.

In the preferred embodiment, the apparatus is stationary and the polymer filament 101 is moved through the chamber 102 by an external force. This external force is typically provided by an extruder mechanism that accompanies 3D printing systems.

In the preferred embodiment, the chamber 102 exterior is insulated so that the user is not exposed to the heat from the apparatus.

The length of the chamber 102 is determined by the rate of moisture removal from the polymer filament 101 and the maximum rate at which the polymer filament 101 will be consumed by the external process. The apparatus must reduce the moisture content of the section of polymer filament 101 by the desired amount by the time the section of polymer filament 101 finally exits the chamber 102.

In the preferred embodiment, the maximum speed of the polymer filament 101 is set to a range of approximately 5-8 mm/sec. Depending on the diameter of the polymer filament 101 and the settings of the external process, this corresponds to approximately 50-75 mm/sec printing speed.

A sample of polymer filaments were saturated with water and then heated in the apparatus at a range of temperature of 140-190 degrees Celsius. From these samples, the moisture content of the polymer filaments was tested for print quality. Using these experiments, a length of approximately 2 meters was determined for the chamber 102 giving a balance of print speed, apparatus temperature and print quality. In the preferred embodiment of the apparatus, the chamber 102 is bent into a circular coil approximately 250 mm in diameter. This provides a good balance between the overall size of the apparatus and the amount of contact friction between the polymer filament 101 and the chamber 102 walls allowing the polymer filament 101 to move smoothly through the chamber 102.

Since the polymer filament 101 must be initially fed through the length of the chamber 102, an initial waiting period of approximately 10 minutes after the apparatus is powered on is required to remove moisture from the initial length of polymer filament 101 before continuous use is possible. In the preferred embodiment of the apparatus, a visual indicator 112 shows that the set desired temperature of the polymer filament has been reached.

### Alternative Embodiments

The chamber 102 must be able to accommodate enough polymer filament 101 so that polymer filament 101 exiting the chamber 102 have had enough time to have the required amount of moisture removed.

While in the preferred embodiment, the chamber 102 is a circularly coiled metal alloy tube, there are different chamber geometries and dimensions that can achieve the desired effect.

In another embodiment, the heater is a metal drum or reel that the section of polymer filament 101 coils around.

In the preferred embodiment, all three heating transfer methods are used to heat the polymer filament 101, however, any combination of heating transfer; conduction, convention and radiation, can be used. In the preferred embodiment, the chamber 102 itself is used to heat the polymer filament 101, however, the heater 103 may be internal to the chamber. The above example of a metal drum heater is one embodiment of the internal heater.

In the preferred embodiment, the chamber 102 is insulated externally. In other embodiments, the chamber itself may be made of insulating material or may be a combination of a heater and insulator as a composite material or assembly.

In the preferred embodiment, the heaters 103 are resistor ceramic heating elements. In other embodiments the heater 103 may be a metal, ceramic, thick film polymer, composite heating element or other composition. The heater 103 may be heated by electricity or by fuel. The heater 103 may use infrared radiation, ultrasound radiation, microwave radiation or other available radiation sources.

Because the heat capacity of the polymer filament 101 is significantly lower than that of the apparatus including the chamber 102, the temperature of the polymer filament 101 can be measured indirectly with accurate results. In the preferred embodiment, the temperature of the polymer filament 101 is measured indirectly by measuring the temperature of the heater 103 attached to the chamber 102 using a thermistor. In other embodiments, the temperature of the polymer filament 101 can be measured either directly or indirectly using a thermistor, thermocouple, semiconductor-based sensor or by using an Infrared temperature sensor.

In the preferred embodiment, the chamber 102 is closed and an air exchanger 105 moves air across the polymer filament 101 heating it and removing moist air from the chamber 102. In another embodiment, the chamber is not fully closed and moist air escapes throughout the chamber allowing for the exchange of air either passively or using an air exchanger 105. In other embodiments, the air exchanger 105 is a vacuum, fan or blower.

In the preferred embodiment, the set desired temperature of the polymer filament 101 is set in the electronic circuit. In another embodiment, buttons, switches or dials 111 are used to set the desired temperature.

In the preferred embodiment, a visual indicator 112 shows the set desired temperature has been reached. In another embodiment of the apparatus, a speaker or piezo buzzer 113 creates an audible sound when the set desired temperature of the polymer filament has been reached.

In the preferred embodiment, an electronic circuit that implements a simple temperature thermostat algorithm is used to implement the temperature controller 109. In another embodiment, the simple temperature thermostat algorithm is implemented by a micro-processor. The microprocessor takes the temperature sensor inputs, buttons, switches or dials inputs and implements the simple temperature thermostat algorithm.

In the preferred embodiment, desired polymer filament temperature is static. In another embodiment, an ambient humidity sensor is used to determine the set desired temperature of the polymer filament 101. In still another embodiment, buttons, switches or dials 111 are used to set the polymer filament type to customize the set desired temperature of the polymer filament 101. In still another embodiment, a sensor measuring the feed rate of the polymer filament 101 is used to determine the set desired temperature of the polymer filament 101. In addition, the feed rate sensor may be used to power down the apparatus when the external process stops using polymer filament 101.

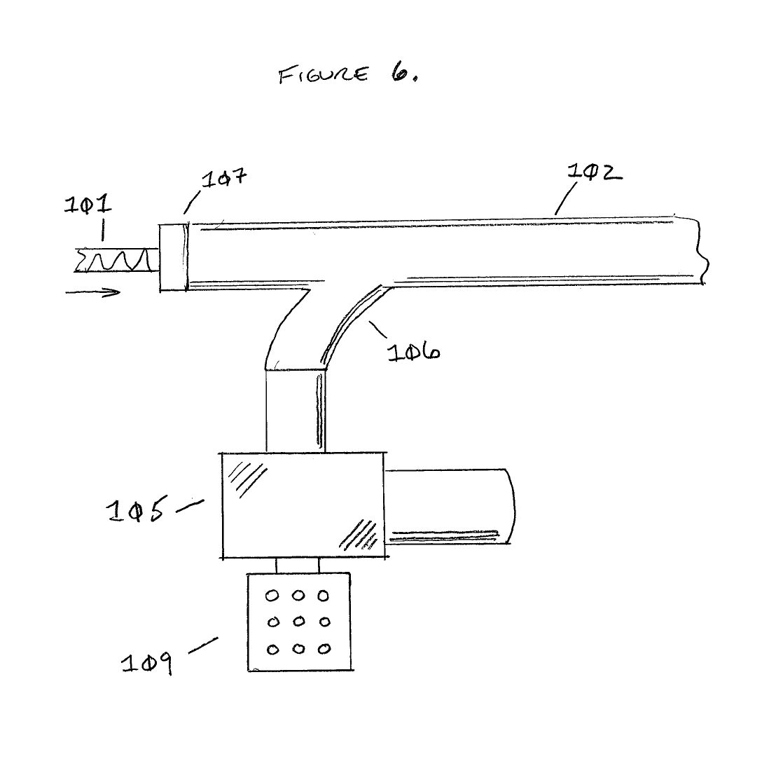

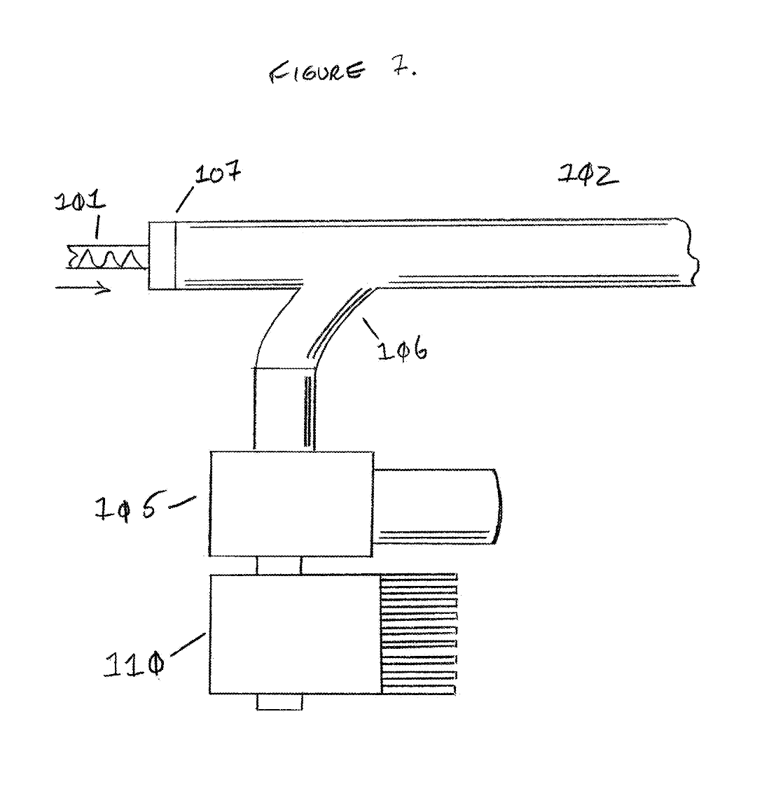

In the preferred embodiment, air entering the air exchanger 105 is ambient air. In another embodiment of the apparatus, desiccant 115 shown in FIG. 6, is used to lower the moisture content of the air entering the air exchanger 105. In yet another embodiment of the apparatus, a dehumidifier 110 shown in FIG. 7, is used to lower the moisture content of the air entering the air exchanger 105.

Although the present invention has been described with reference to preferred embodiments, numerous modifications and variations can be made and still the result will come within the scope of the invention. No limitation with respect to the specific embodiments disclosed herein is intended or should be inferred.

1. An apparatus for removing moisture from a section of polymer filament, comprising:
a chamber surrounding the section of polymer filament;
at least one heater for heating the polymer filament while inside the chamber;
an air exchanger used to replace moist air in the chamber with less moist air;
at least one temperature sensor for measuring the temperature of the polymer filament in the chamber;
and a temperature controller for regulating the temperature of the polymer filament, the temperature controller adjusting the heater by comparing the temperature or the polymer filament read by the temperature sensor to the desired polymer filament temperature.

2. The apparatus for removing moisture from a section of polymer filament as recited in claim 1, wherein the polymer filament is heated by conduction with the polymer filament in direct contact with the heater.

3. The apparatus for removing moisture from a section of polymer filament as recited in claim 1, wherein the polymer filament is heated by convection with the heater heating the air surrounding the polymer filament.

4. The apparatus for removing moisture from a section of polymer filament as recited in claim 1, wherein the heater heats the polymer filament by radiation.

5. The apparatus for removing moisture from a section of polymer filament as recited in claim 1, wherein the heater heats the chamber transferring heat to the polymer filament.

6. The apparatus for removing moisture from a section of polymer filament as recited in claim 1, wherein the chamber surrounding the section of polymer filament is a metal tube.

7. The apparatus for removing moisture from a section of polymer filament as recited in claim 1, wherein the air exchanger is an air pump.

8. The apparatus for removing moisture from a section of polymer filament as recited in claim 1, wherein the air exchanger is a fan.

9. The apparatus for removing moisture from a section of polymer filament as recited in claim 1, wherein the air exchanger is a vacuum.

10. The apparatus for removing moisture from a section of polymer filament as recited in claim 1, wherein the temperature of the polymer filament is measured indirectly by measurement of the temperature of the chamber itself.

11. The apparatus for removing moisture from a section of polymer filament as recited in claim 1, wherein the temperature of the polymer filament is measured indirectly by measurement of the heater(s).

12. The apparatus for removing moisture from a section of polymer filament as recited in claim 1, wherein the temperature of the polymer filament is measured indirectly by measurement of the air in the chamber.

13. The apparatus for removing moisture from a section of polymer filament as recited in claim 1, wherein the temperature of the polymer filament is measured directly by an IR sensor.

14. The apparatus for removing moisture from a section of polymer filament as recited in claim 1, wherein the temperature of the polymer filament is measured directly by a contact sensor.

15. The apparatus for removing moisture from a section of polymer filament as recited in claim 1, further comprising a desiccant used to remove moisture from the air entering the air exchanger.

16. The apparatus for removing moisture from a section of polymer filament as recited in claim 1, further comprising a dehumidifier used to remove moisture from the air entering the air exchanger.
